(19) United States
(12) Patent Application Publication
(10) Pub. No.: US 2007/0044211 A1
(43) Pub. Date: Mar. 1, 2007

(54) Post surgical abnominal splint; non-latex

(76) Inventor: Edwin Vincent Conkle, Missoula, MT (US)

Correspondence Address: Edwin V. Conkle, 2814 Brooks St # 104, Missoula, MT, 59801, US

(21) Appl. No.: 11/214,668

(22) Filed: Aug. 31, 2005

(51) Int. Cl. A62B 17/00; A41D 13/00

(52) U.S. Cl. 2/457

(57) ABSTRACT

Disclosed is a securable torso wrap. The wrap includes a front laminated panel comprised of a cotton duck cloth interior and a Velcro type loop exterior panel. The rear panel is comprised of cotton duck cloth with a plurality of hook and loop straps, which attach to the front panel to secure the device. The entire invention is devoid of any elastic properties making it latex free.

### BACKGROUND OF THE INVENTION

This invention relates in general to body wraps and to a non elastic, latex free, drain tube compatible splint in particular.

With any abdominal injury or surgery the priority is the protection of the wound or incision site. This is achieved by constraint to prevent rupture of the wound or incision. Unless proper support is provided, sutures or staples may fail causing a reopened wound and possible infection.

After surgery it is of paramount importance that the patient is able to deep breath and cough in order to decrease chances of pulmonary complications and post-operative respiratory problems. These functions can cause rupture unless adequate abdominal support is present.

Various elastic binders and abdominal wraps are available for the constraint and restriction of torso expansion, however, their stretchable nature allows the wound to flex outwardly thus producing undue stress on sutured tissue. Increased support promotes greater mobility sooner, which in turn decreases recovery time.

In all cases of abdominal injury or surgery, best practice dictates protection of the incision site, pain management and patient comfort.

It is evident that a need has arisen for a non elastic latex free abdominal splint available in multiple sizes to ensure proper fit and provide maximum support and protection. There is concomitant need for a splint which is drain tube compatible and allows easy access to the wound or incision.

### DETAILED DESCRIPTION AND SPECIFICATIONS OF THE INVENTION

For the purpose of illustrating and specifying the invention, there shown in the drawings and related in the specifications a form which is presently preferred; it being understood, however, that this invention is not limited to the precise arrangements and instrumentalities shown.

In Reference to FIG. 1

The back panel (G) is cut from 10 oz cotton duck cloth. The edges are serger stitched with 16 oz 100% spun polyester thread using wide 1 needle and 3 threads.

In Reference to FIG. 3

The front panel (B) is cut from 10 oz cotton duck cloth. A Velcro type low pile warp knit loop material with napped finish is laminated to the front panel (B) by multiple horizontal straight-line stitches. The edges are serger stitched with 16 oz 100% spun polyester thread using wide 1 needle and three threads.

In Reference to FIG. 2

The distal end of the Velcro type low pile warp knit loop material with a napped finish (A through F) is folded back one half inch to the non-loop side and the Velcro type low pile warp knit hook material with a napped finish is straight stitched to over the fold to provide a pull tab to allow for adjustments and release.

In Reference to FIG. 1

Two inch wide straps (A through F) are cut from the Velcro type low pile warp knit loop material are stitched two inches into the exterior of the back panel (G) with the loop side facing outward and the hook section facing inward.

### SUMMARY OF THE INVENTION

In summary, there has been provided an abdominal/torso wrap or splint, which is non-stretchable in nature providing maximum support and protection for the wound or incision site. In addition the invention is breathable and latex free. Comprising of only four different materials, its effectiveness is enhanced by its simplicity of design, which in turn facilitates fabrication and reduces manufacturing costs.

Although the invention has been described above with a certain degree of particularity with respect to materials and construction thereof, it should be understood that this disclosure has been made only by way of example. Consequently, changes in the details of the construction and in the arrangements of the elements, as well as possible modes of utilization, will become apparent to those familiar with the art, and may be resorted to without departing from the scope of the invention as claimed.

### BRIEF DESCRIPTION OF THE DRAWINGS

FIG. 1 is an external perspective view of the back panel (G) with attachment straps consisting of the loop component material. (A through F).

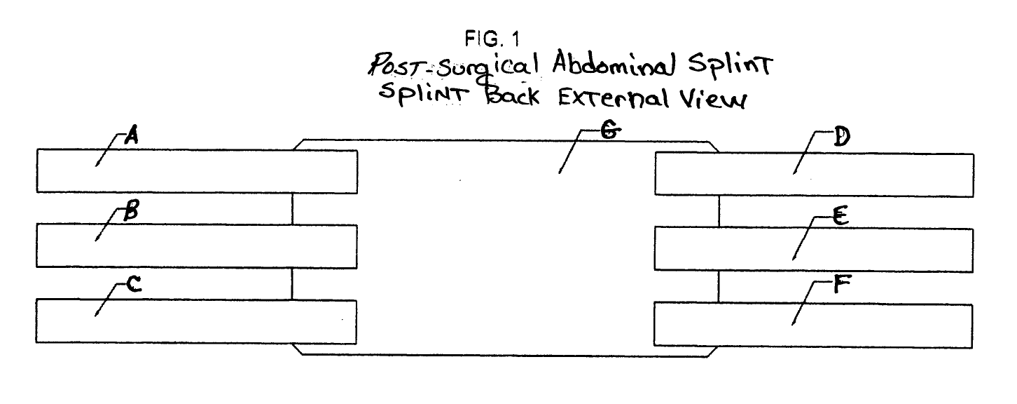

FIG. 2 is the reciprocal, or internal perspective view of the same back panel (G) with attachment straps providing the hook material component on the interior distal end of each strap. (A through F).

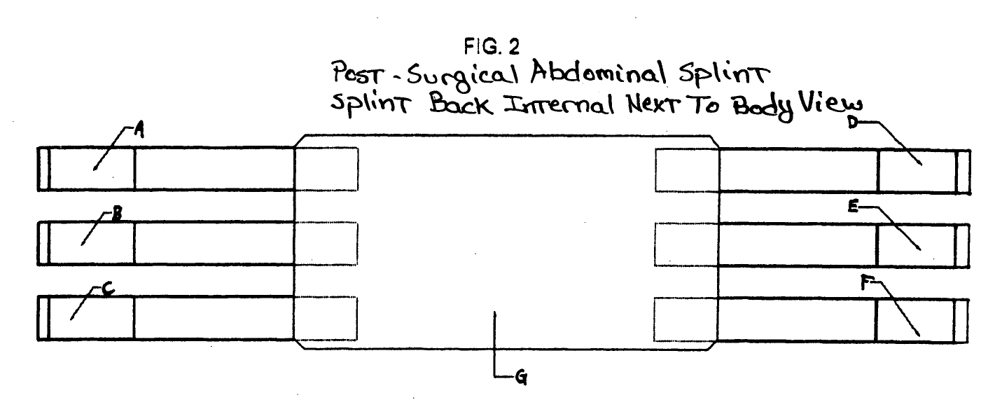

FIG. 3 is an external perspective view of the front laminated panel. (A & B)

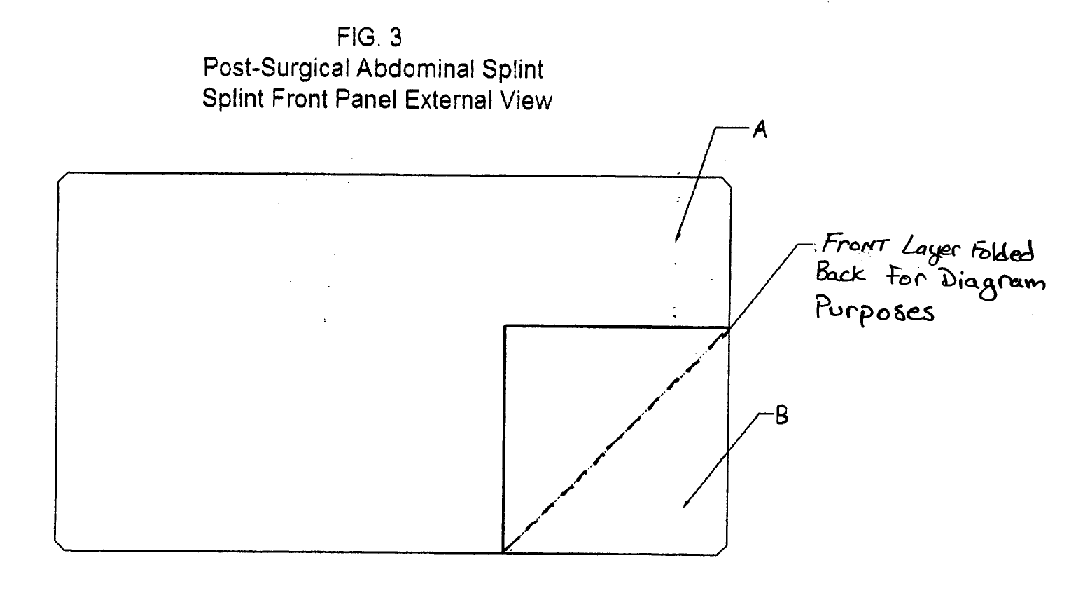

FIG. 4 is the reciprocal or internal perspective view of the same front laminated panel.

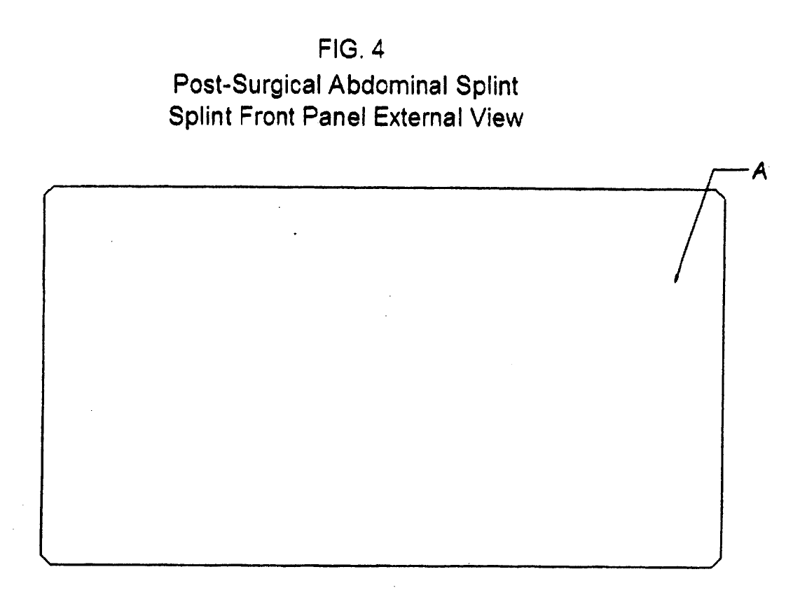

FIG. 5 is an elevational view of the invention secured about the torso of the patient.

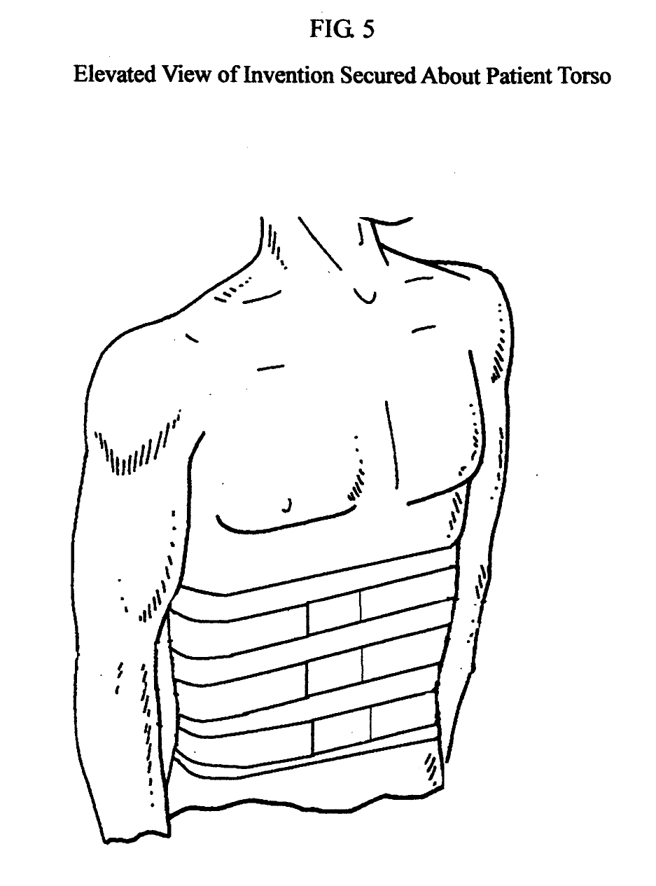

1. A securable torso wrap comprised of the following materials:
10 oz. cotton duck cloth.
Low pile warp knit loop material with a napped finish.
Low pile wrap knit hook material with a napped finish.
16 oz. 100% spun polyester thread.
These materials are fabricated in the following configuration

2. A rectangular rear panel with a plurality of non-stretchable multidirectional hook and loop type straps attached to the distal ends of the panel.

3. A laminated rectangular front panel of which the exterior aspect is comprised of a Velcro type loop material and the interior aspect is comprised of cotton duck cloth.

4. Application of the invention can be achieved in either the prone or upright positions by deployment of the non-stretchable multidirectional hook and loop straps to the exterior of the front panel.

5. In accordance with claim 1, all materials are breathable, generally promoting natural healing of the wound and decreasing the risk of infection.

6. In accordance with claim 1, all materials are non-stretch, which allows the invention to maintain a structural rigidity to provide maximum protection and support by minimizing the outward flex of the wound during patient movement and mobility.

7. In accordance with claim 1, the lack of elasticity ensures a precise fit that does not require constant adjustments

8. In accordance with claim 1, being non-stretchable in nature, the invention is completely devoid of any elastic materials rendering the invention latex free. This eliminates all and any issues of latex intolerance, latex allergies and, in extreme cases, anaphylactic reactions.

9. In accordance with claim 1, either front or rear panel material can be cut horizontally to allow for drain tube compatibility with no loss of structural integrity.
